(19) United States
(12) Patent Application Publication
(10) Pub. No.: US 2014/0326419 A1
(43) Pub. Date: Nov. 6, 2014

(54) WINDBREAK SYSTEM

(71) Applicant: ALLGRASS CONFORT SYSTEMS S.L., Malaga (ES)

(72) Inventors: Francisco Ona-Gonzalez, Malaga (ES); Jorge Luis Perez-Falcon, Malaga (ES)

(21) Appl. No.: 14/126,448

(22) PCT Filed: Jun. 24, 2011
(86) PCT No.: PCT/ES2011/000210

§ 371 Date: Jun. 16, 2014

(51) Int. Cl. E06B 9/00; E06B 3/50; E04H 15/00

(52) U.S. Cl. CPC E06B 9/00; E04H 15/005; E06B 3/5054; E06B 2009/005
USPC 160/115

(57) ABSTRACT

The invention relates to a windbreak system formed by: a set of independent panels that can be controlled individually, by moving the same longitudinally along an upper rail and a lower rail: and a folding door at one of the ends. Each panel and door comprises a rotation shaft and a folding shaft. The panels are moved manually, without bearing on rollers, and the entire weight of the panels rest on two strips of self-lubricating polymers that are inserted into two slots in the lower rail. The upper and lower rails are identical and have a rectangular cross-section and the panels are made from glass.

### FIELD OF THE INVENTION

The present invention is an addition to the patent request PCT/ES2010/000187 “Sistema paravientos”. This invention can be included in technical sector of building systems or materials

### STATE OF THE ART

Patent request PCT/ES2010/000187 “Sistema paravientos” lists the most significant prior patents related to this request. This addition to patent request contains a set of independent panes that can be individually operated sliding them along a top and bottom track and a foldable door. Each pane and door has a pivot axis and a folding axis. Panes are operated manually and have no bearings, resting the weight of the panes over two self-lubricating polymer strips, inserted in two channels in the bottom track. The operation of the system is based in a set of elements that allow the panes to fold and slide along the tracks in order to achieve the best isolation and best durability.

### SUMMARY OF THE INVENTION

The present addition comprises the following changes and enhancements comparing to the initial patent request:
1. New top and bottom profiles, replacing the former ones.
2. A levelling system has been included, it is formed by a levelling profile and a set of eccentric nuts and screws used to keep together the bottom track and the levelling profile.
3. Top and bottom turning sets are replaced for new ones, quite similar to the former ones.
4. A new top guide replaces the former version.
5. Caps are added to the bottom track ends.
6. The door locking systems mechanism is replaced by a new one.
7. The turning mechanism has a new set of components.
8. A two-part adjustable corner plate has been introduced to ease the joint in the corners formed by two sections of the system.
9. There is a new top turning set for the pivot movement of the panes that avoids the use of the guide-arm.
10. Former bottom guide version has been replaced by a new one.
11. A corner wedge has been added, it fits into the two-part adjustable corner plate.

First addition, wherein the new top profile has a flat base and side arms, with small protuberances up to 0.5 mm long on their inner faces, to improve the union between the glass and the aluminium profile. Both arms have a cavity on the top area to collect the excess of glue which could leak out of the profile during the glueing process. The terminations of these arms have two flat sides to hide the view of the bonding material that fixes the glass and aluminium from the outside. The bottom area of the profile has an inverted “U” shape hole to insert and fix the new top turning set and top guide set.

Second addition, wherein a new bottom profile also has a flat base and side arms with protuberances, teeth like, of a size up to 0.5 mm, on their interior face to improve the bonding between the glass and the aluminium profile. The bottom area of the profile has an inverted “U” shape hole to insert bolts that fix this profile to the bottom sliding profile base and allow a height regulation of this profile inside the other one to overcome the glass imperfections originated in the glass cutting process.

Third addition, wherein a new “U” shape levelling profile accommodates levelling sets, formed by an eccentric bolt and a flat head screw. The screw has a circular head with a diameter big enough to assure a stable support of the aluminium track, the height of the screw is design to level the track on uneven floor or ceiling surfaces. The eccentric bold has the precise dimensions to fit perfectly on the levelling profile base and avoid any undesired movement and also provide a stable support basement for the whole system. On top of the levelling sets is placed the bottom track. The arms of the levelling profile centre the track and hide the levelling sets and fixation screws. The levelling profile base has two corner holes to insert a cap to avoid indoor water leakage at the track ends.

Fourth addition, wherein a new top turning set has a metal body and a top guide bushing. The base of the metal body is a plate with three layers and a protuberance. First layer assures the right coupling in between the panes when they are being deployed. This layer has a reference mark to insert this set in the correct position in such a way that all the panes will have the sets fitted at the same distance in the top profile. On the second layer there are small, teeth like, protuberances up to 0.5 mm long, to fix tightly the set to the aluminium top profile. The width of the third layer assures a centred position of the set in relation to the pane, as it has the same width as the top profile opening. The protuberance has a wedge shape to support the set body and to assured a vertical position of the axis over the top aluminium profile, and removing a second screw present in the former version. The top guide bushing has a circular shape and two layers. It is made in one piece of polyamide or similar material. This bushing is inserted by pressure into the rounded metal head of the top turning axis. The outer diameter in the bushing assures the centred position of the pane in relation to the track and avoids noises when the panes are sliding.

Fifth addition, wherein a new bottom turning set has a metal part with two bodies and a bottom guide bushing. The metal part is form by two bodies assembled by an arrow locking joint, also known as click, that allows a part to enter into the other one but not to exit from the other one, it creates a rigid union that can't be disassembled. The base of the metal body is a plate with three layers and a protuberance. First layer assures the right coupling in between the panes when they are being deployed. This layer has a reference mark to insert this set in the correct position in such a way that all the panes will have the sets fitted at the same distance. On the second layer there are small, teeth like, protuberances up to 0.5 mm long, to fix totally the set to the aluminium bottom sliding profile. The width of the second layer assures a centred position of the set in relation to the bottom sliding profile, as it has the same width as the profile opening. The protuberance has a wedge shape to support the set body and to assured a vertical position of the axis in relation to the bottom aluminium sliding profile, and removing a second screw present in the former version of this set. The bottom guide bushing has a “T” shape, side faces are flat and the front and rear ones are rounded. The bushing width is smaller than the aluminium track opening, therefore the panes can be mounted and dismounted without the need of a hole in the track. The bottom guide bushing is centred in relation to the set axis, but is not fixed, making possible to keep the parallelism between the flat sides of the bushing and the aluminium track.

The bottom guide set solves a problematic situation present in the former version, as during the installation process it was necessary to insert a metal pin inside the plastic bushing, a delicate process that sometimes broke the plastic bushing. Also this breaking could happen if the operation of the panes was not correct or an object could fall inside the track and block the normal operation of the bushings. This breakage involved dismounting the whole system as the former bushing can't be introduced into the track from the top, it has to be done from one side of the track. So, there is no need to design a specific hole in the track as the new version allows the top-down insertion into the track. Therefore, the bushing width allows the panes to be mounted and dismounted without the need of a hole in the track to insert these new sets inside.

Sixth addition, wherein a new top guide set has a metal body and a top guide bushing. The base of the metal body is a plate with two layers, an axis, and a protuberance. On the first layer there are small, teeth like, protuberances up to 0.5 mm long, to fix tightly the set to the aluminium top profile. This layer has a downward slope at its front end to ease the movement of the set along the top profile longitudinal hole. The width of the second layer assures a centred position of the set in relation to the top profile, as it has the same width as the profile opening. The protuberance has a wedge shape to support the set body and to assured a vertical position of the axis over the top aluminium profile, and removing a second screw present in the former version. The top guide bushing has a circular shape and two layers. It is one piece made of polyamide or similar material. This bushing is inserted by pressure into the cylindrical metal head. The outer diameter in the bushing assures the centred position of the pane in relation to the track and avoids noises when the panes are sliding.

Seventh addition, wherein a cap is placed at both ends of the bottom track. The shape is the same as the track hole, so it can fit in perfectly. The bottom track outside face has small draining holes, therefore in case of water leakage from the panes joints, it can flow outdoors.

Eighth addition, wherein a new top locking block replaces the former locking mechanism described in the previous patent request. The block has a base with a protuberance aim to position it perpendicularly to the top aluminium profile, avoiding any possible movement of this block. In the front side there is another protuberance working as a stopper against the interior side of the top aluminium profile, positioning the door in relation to the top aluminium track. This way, the door is in line with the rest of the panes. Both protuberances position the block in relation to the top aluminium profile and the top track, avoiding accidental marks or scratches during the installation on the outer faces of these profiles.

Ninth addition, wherein a new pivot block and a turning mechanism set substitute former turning mechanism. This new set is formed by a pivot block and a turning mechanism that are assembled, giving as a result, one body. The new pivot block replaces the former pivot cubes, made of polyamide, on top and bottom, from the first patent request. The pivot block has a rectangular shape in all its sides, and a hole that is slightly not centred as the top and bottom axes must have a shift between them for the correct operation of the system. There are two sides with a protuberance and a hole each, on their bottom. These shapes, identical to all the pieces, are used to assemble the components in the new turning mechanism. The new turning mechanism has plates with two spoons, or half moons, each, all these plates have identical protuberances for the assembly between them and to the pivot block.

The new turning mechanism and pivot block set can be used on top and bottom of the windbreak system, and in any other possible opening configuration, without any mechanical operation in the components. To achieve this, the pivot block on the bottom must be assembled to the spoons plate using a different protuberance than the one used in the top pivot block, as the axis hole position is not symmetric in the longitudinal axis defined by the longest sides of the block. This way, the installation process is easier and more reliable than the one described in the former patent request.

Tenth addition, wherein two-part adjustable corner plate can couple different sections, it can happen when there is an angle and two tracks must be connected. Moreover, the two-part adjustable corner plate assures that both sections won't move once they are assembled during the operation of the system. The two-part adjustable corner plate has two identical plates connected by a joint in their rounded shape sides. These semicircular ends have a step so they can couple by means of the joint. This step is delimited by two straight edges forming an interior angle of 270°, this way, the set can be used to connect sections with an angle within a range of 45° to 315°. The other small side is straight. Along the central axis of the plates there is an oval hole, whose longer axis is parallel to the longer sides of the plate, and a circular hole, being the oval ones closer to the small straight side of the plate.

The oval hole is always used before the other one, as it allows a regulation on the connection process of the tracks. The second hole is used for the final fixing, once the tracks are connected properly.

Eleventh addition, wherein a new top turning set eliminates the need of using the guide-arm when folding the panes. The new set is formed by a metal axis and a blocking bushing. The metal axis has a cylindrical shape. The bottom area of the axis has a semicircular shape to be inserted in a fixing plate. Around the middle of the axis there are two wings connected, with a ramp shape. This ramp will allow the blocking bushing to go up the axis until it reaches the pivot position at the top turning mechanism height. At the top of the axis there is a head with a small ramp that will press the blocking bushing down the axis when the pane is going to be deployed, so it can leave the top turning mechanism. The front side of the head has a rounded shape and will block the pane when folded, as the axis rotates approximately 90° in relation to the blocking bushing.

The blocking bushing has two layers. The first one, the one with the bigger diameter, has a ramp that will elevate the bushing, when meeting the axis ramp, up to the top turning mechanism height. The second layer is symmetric to the central vertical axis and has an interior ramp in the inner hole and two rounded sides to block the metal axis head when it starts the rotation movement. When the pane is going to be deployed the central ramp in the blocking bushing will slide downward over the axis head ramp and will down the blocking bushing, therefore leaving the top turning mechanism.

Twelfth addition, wherein a new bottom guide, having a metal plate and a washer, made of polyamide or similar material, replaces the former one. The base of the metal body is a plate with two layers. On the first layer there are small, teeth like, protuberances up to 0.5 mm high, to fix totally the set to the aluminium bottom profile. The opposite side of the first layer base has a channel with a width equal to the width of the opening of the aluminium bottom profile, so they are both in line. The height of the second layer is the same as the thickness of the base of the bottom profile, so when this plate is fixed, this layer will be at the same level as the base of the bottom profile, making the base, at this point, a flat continuous surface. The plate is made in one piece by injection to assure that all the dimensions and symmetries are correct. This way, the set will work properly and will eliminate the minor differences in measurements among the plates in different production batches.

The washer, made of polyamide, has a round shape and a hole along its vertical axis, having two layers with different diameters. The bigger diameter layer is designed to keep the pane in line with the aluminium bottom track. The washer head has a smaller diameter than the former and is used to couple with the metal body, by an arrow locking or click system, and keep them together. Nevertheless, the washer can rotate freely as its cylindrical interior hole matches a cylindrical pin based on the first layer of the metal body and with a height equal to the second layer. This new bottom guide set eliminates the need of making a notch in one of the two sliding strips inserted in the bottom track, making this support area completely flat and continuous. This way the base of the bottom profile won't hit or get stuck in the sliding strips during the pivoting movement, making the operation of the system smoother. Another improvement is that the possibility of damaging the strips, while folding the panes, is removed.

Thirteenth addition, wherein a wedge has three layers with a rounded side. First layer is a base placed underneath the two-part adjustable corner plate. It has that rounded side to allow the plates to move while connecting two tracks, and at the same time, keep the wedge at a fix position when the panes pass along the corner. The second layer connects the first and third one and fills the gap in between the corner and the rounded plates when connecting two sections with angles. The third layer has a rounded shape to avoid the bottom turning bushing to get stuck in the corner and pass along the tracks smoothly from one section to another.

The following parts are made in one piece by injection to assure the right measurements for a perfect coupling among them and eliminate possible flaws in the fabrication batches:
Top turning set metal body
Two metal bodies in the new bottom turning set
Caps for the track ends
New locking block
Pivot block and turning mechanism
Two-part adjustable corner plate
Metal axis and blocking bushing in the new top turning set that eliminates the need of the guide-arm
Plate in the new bottom guide
Wedges, making easier the coupling of this part with the two-part adjustable corner plate

The material used for these metal bodies can be aluminium, stainless steel or other metallic alloy.

### SHORT DESCRIPTION OF THE FIGURES

FIG. 1: Top profile side elevation.

FIG. 2: Bottom profile side elevation.

FIG. 3: Levelling profile side elevation.

FIGS. 4 and 5: Levelling set side view and side elevation.

FIGS. 6 and 7: Top turning set side view and side elevation.

FIGS. 8 and 9: Bottom turning set side view and side elevation.

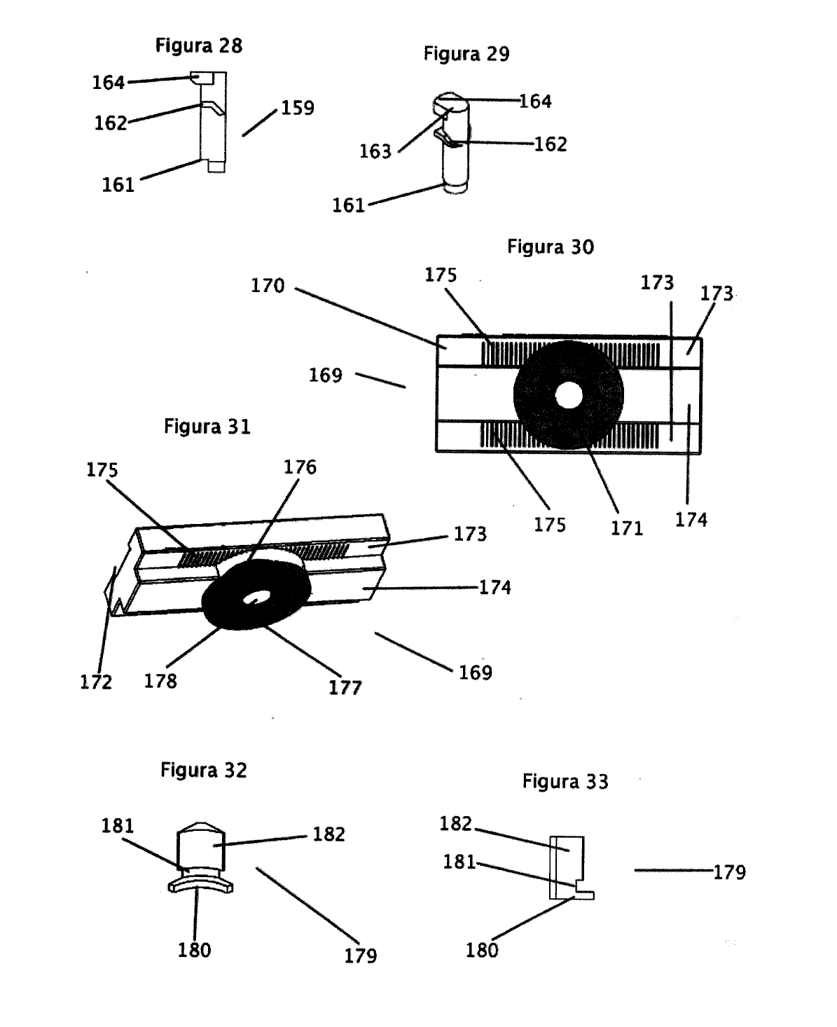

FIGS. 10 and 11: Top guide set side view and side elevation.

FIGS. 12 and 13: Locking block side elevation and side view.

FIGS. 14 and 15: Pivot block and turning mechanism side view and side elevation.

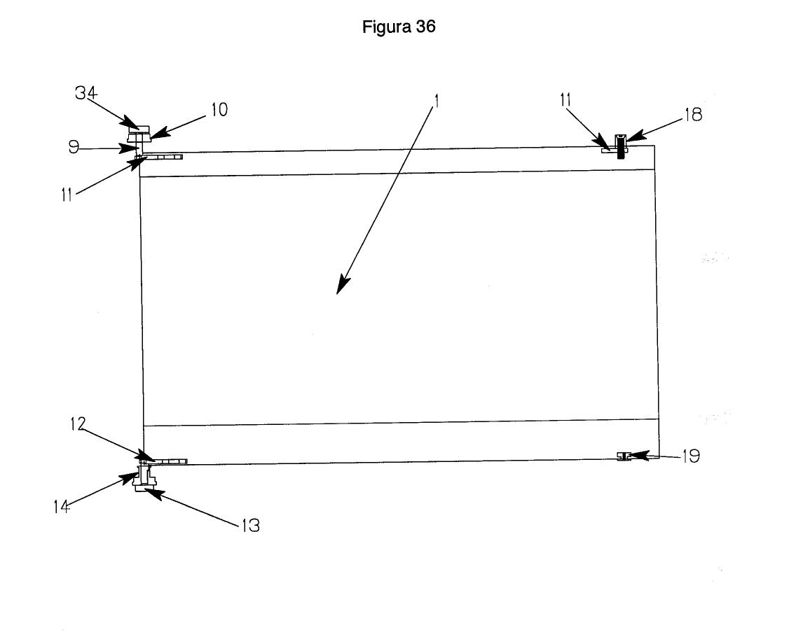

FIGS. 16 and 17: Pivot block and turning mechanism top plan and side elevation in a different configuration.

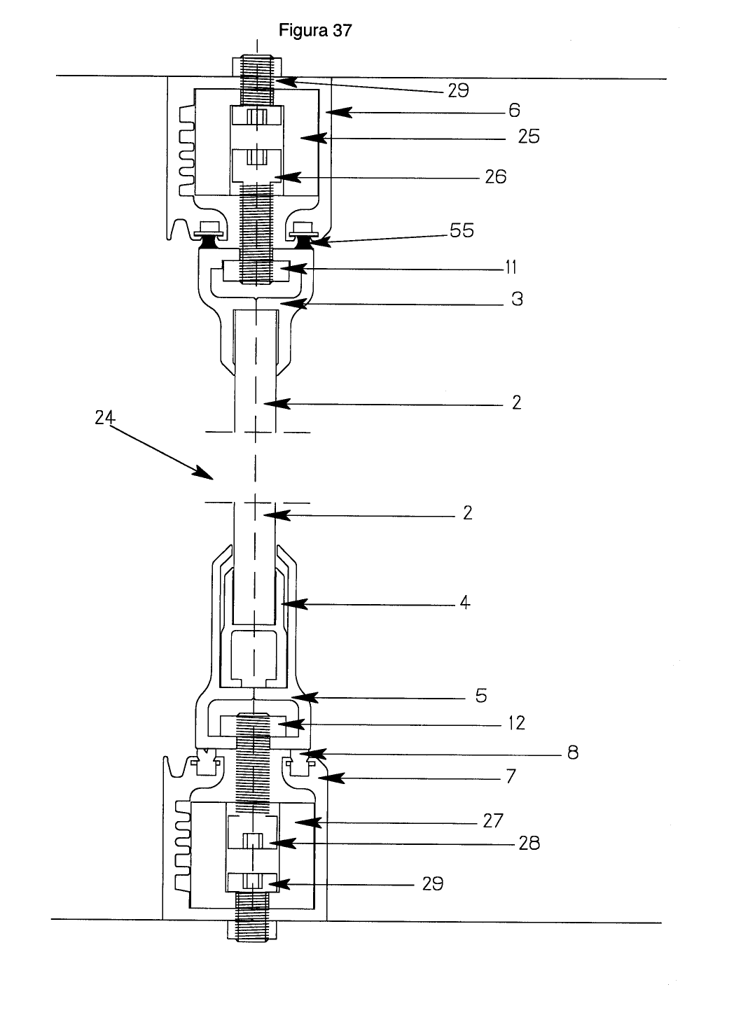

FIG. 18: Cap for track ends side elevation.

FIGS. 19 and 20: Pivot block top plan and side elevation.

FIGS. 20 and 21: Turning mechanism module top plan and side elevation.

FIGS. 23 and 24: Two-part adjustable corner plate top plan and side elevation.

FIGS. 25, 26 and 27: Blocking bushing top plan, side view, and side elevation.

FIGS. 28 and 29: Metal axis side view and side elevation

FIGS. 30 and 31: New bottom guide top plan and side elevation

FIGS. 32 and 32: Curved wedge side elevation and side view

FIGS. 34 to 57: Parts from the initial patent request.

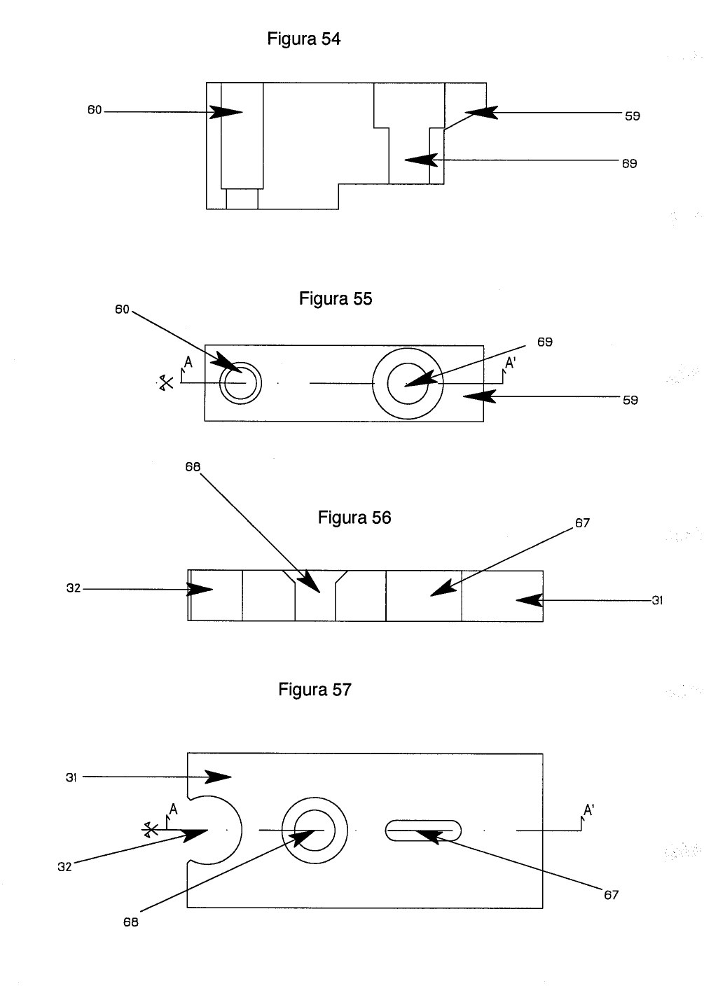

### EMBODIMENT EXPLANATION

Patent request PCT/ES2010/000187 describes the parts of the windbreak system following this numbering:
1. Pane (1)
2. Glass (2)
3. Trapezoidal aluminium top profile (3) of the pane (1).
4. Trapezoidal aluminium bottom profile (4) of the pane (1).
5. “H” shape bottom sliding profile (5).
6. Top track (6).
7. Bottom track (7).
8. Strips made of a homogenoeus mixture of polymer (8).
9. “T” axis guide (9).
10. Top bushing guide (10).
11. Steel plate (11)
12. Bottom steel plate (12).
13. Bottom “T” axis guide (13).
14. Bottom bushing guide (14).
15. Top and bottom turning mechanism (15).
16. Spoons or half moons (16).
17. Turning mechanism base (17).
18. Top guide bushing (18).
19. Bottom guide “H” washer.
20. Semicircular hole (20) located at one end of the steel plate (11, 12).
21. Steel plate (11,12) threaded holes (21).
22. Sliding door bottom bushing (22) with five layers and similar to the bottom bushing (14).
23. Guide-arm (23) made of stainless steel.
24. Door (24).
25. Door top cubic pivot (25) made of polyamide.
26. Door top axis screw (26).
27. Door bottom cubic pivot (27) made of polyamide.
28. Door bottom axis screw (28).
29. Screws (29) to fix cubic pivots (25, 27) to the ceiling and floor.
30. Bottom guide screw (30) crossing the top guide bushing (18) and fits into a threaded hole in the steel plate (11).
31. Sliding door bottom plate (31).
32. Semicircular notch (32) at one end of the sliding door bottom plate (31).
33. Opening (33).
34. “T” axis head (34).
35. Bottom lock (35) of the door (24).
36. Top aluminium profile (3) side arms (36).
37. Side arms (36) protuberances (37).
38. Flat base (38) in top aluminium profile (3) of pane (1).
39. Top aluminium profile (3) hole (39).
40. “H” shape bottom aluminium profile (4) side arms (40).
41. Side arms (40) protuberances (42).
42. Rectangular hole (42) in the half opened bottom profile (4) of pane (1).
43. Straight side arms (43) covering the side arms (40). Side arms (43) are part of the bottom sliding profile (5).
44. Flat base (44) in bottom sliding profile (5).
45. Hole (45) in profile (5) where steel plate (12) is placed.
46. Exterior sides (46) in the base of bottom profile (5).
47. Track side (47) with exterior and interior flat face in top (6) and bottom track (7).
48. Track side (48) with exterior flat face and interior with protuberances (49) in top (6) and bottom track (7).
49. Protuberances (49) on interior track side (48).
50. Screws or bolts (50) to fix the top (6) and bottom track (7) to the ceiling and floor.
51. Longitudinal channel (51) in top (6) and bottom track (7).
52. Longitudinal channel (52) in top exterior side (57) close to side (47).
53. Longitudinal cannel (53) in top exterior side (57) close to hole (56).
54. Longitudinal channel (54) in top of exterior side (57) in side wall (48).
55. Wind and water protecting brushes (55).
56. Opening (56) of top (6) and bottom track (7).
57. Exterior side (57) of top (6) and bottom track (7).
58. Guide-arm (23) hole (58).
59. Door (24) locking mechanism (59).
60. Rod (60) of up and down mechanism for the pin (56).
61. Spring (61) of up and down mechanism for the pin (56).
62. Guide-arm (23) flat side, parallel to the floor and containing two holes (57, 58).
63. Guide-arm perpendicular flat side (63).
64. Horizontal stepped side (64) for fixing through 3 holes (66).
65. Vertical stepped side (65) for fixing through 3 holes (66).
66. Fixing holes (66) on top of interior side of top track (6).
67. Long hole (67) of the sliding door plate (31).
68. Circular hole (68) of the sliding door plate (31).
69. Door (24) locking mechanism (59) fixing hole (69).
70. Steel plate (70) for fixing the door (24) locking mechanism (5).

From the former set of elements, the present patent addition describes 13 modifications including new version and additional parts in order to improve the fitting process and the system performance.

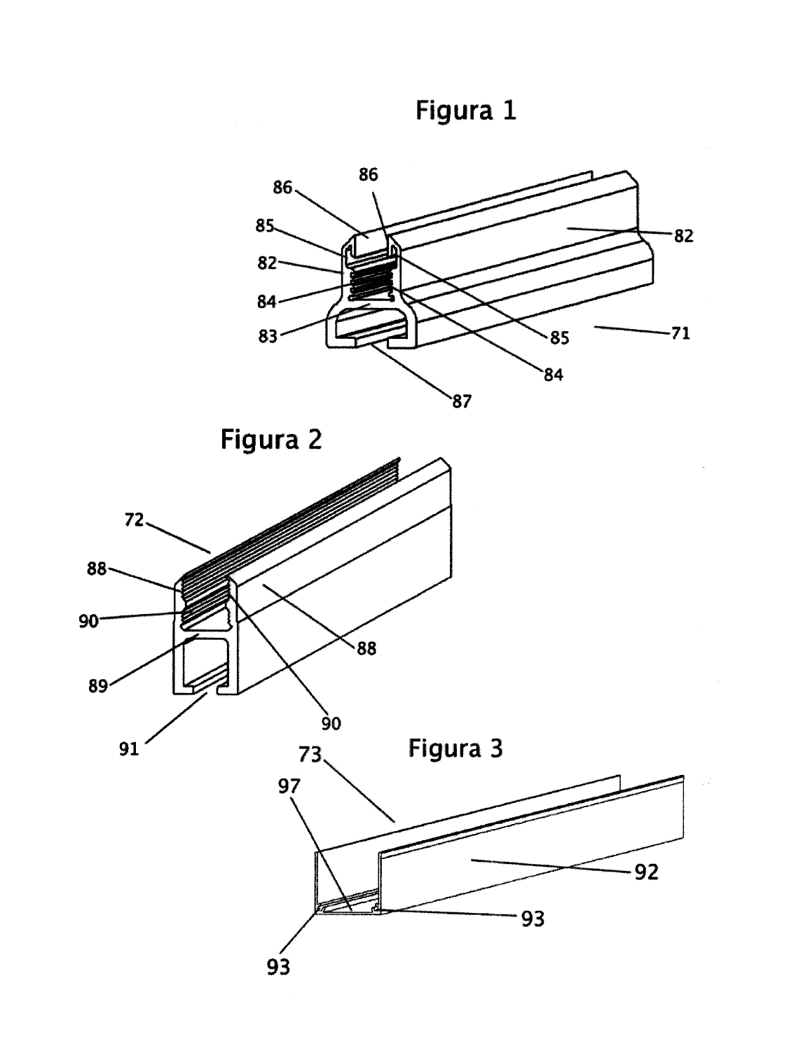

First addition, wherein a new top profile (71) is described as depicted in FIG. 1. The glass (2) is glued to the side arms (82) and the flat base (83) of the new top profile (71). These sides (82) have an arm shape, having on their inner faces small protuberances (84), teeth like, to improve the glass (2) and aluminium profile (71) union. Both arms (82) have a cavity (85) on the top area to collect the excess of glue that could leak out of the profile during the glass (2) glueing process. The terminations of these arms (82) have two flat sides (86) to hide the view of the bonding material that fixes the glass and aluminium from the outside. This way, a wide range of glueing materials, in different formats and colours, can be used. The bottom area of the profile has an inverted “U” shape hole (87) to insert and fix the new top turning set (75) and top guide set (77).

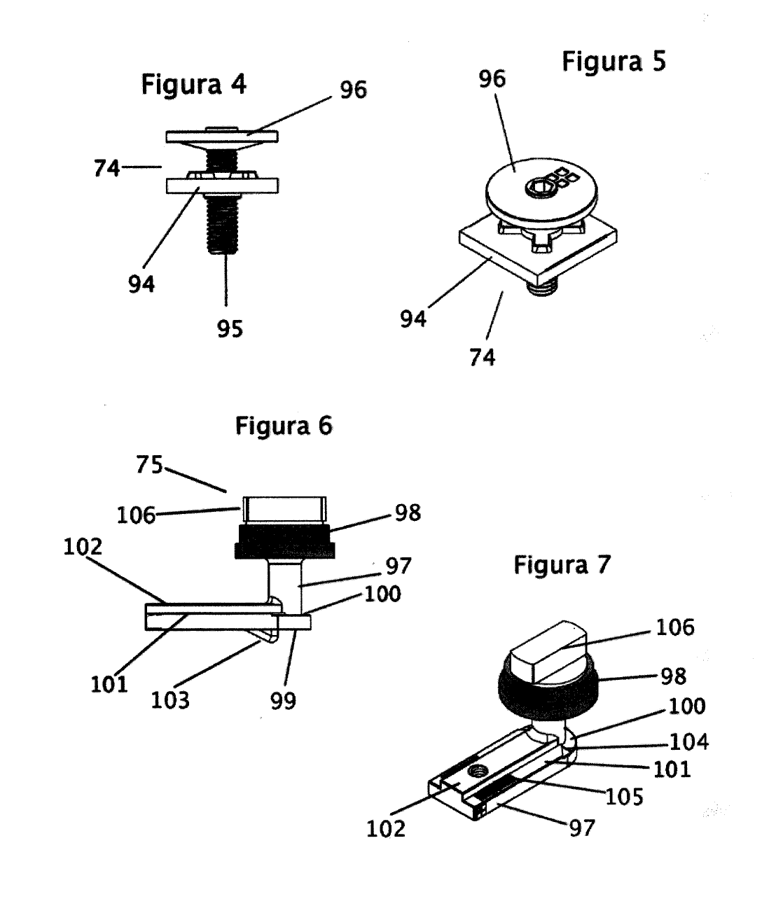

Second addition, wherein a new bottom profile (72), as shown in FIG. 2, is described. The glass (2) is glued to the side arms (88) internal faces and to a flat base (89) of the new bottom aluminium profile (72). As in the top profile (71), side arms (88) have, on their interior face, small protuberances (90), teeth like, up to 0.5 mm long, to improve the bonding between the glass (2) and the aluminium profile (72). The bottom area of the profile has an inverted “U” shape hole (91) to insert two bolts, not shown in the figure, that fix this profile to the bottom sliding profile (5) base and allow a height regulation of this profile (72) inside the other one to overcome the glass (2) imperfections originated in the glass cutting process. This makes possible to align a big side of a pane to another or slightly not squared.

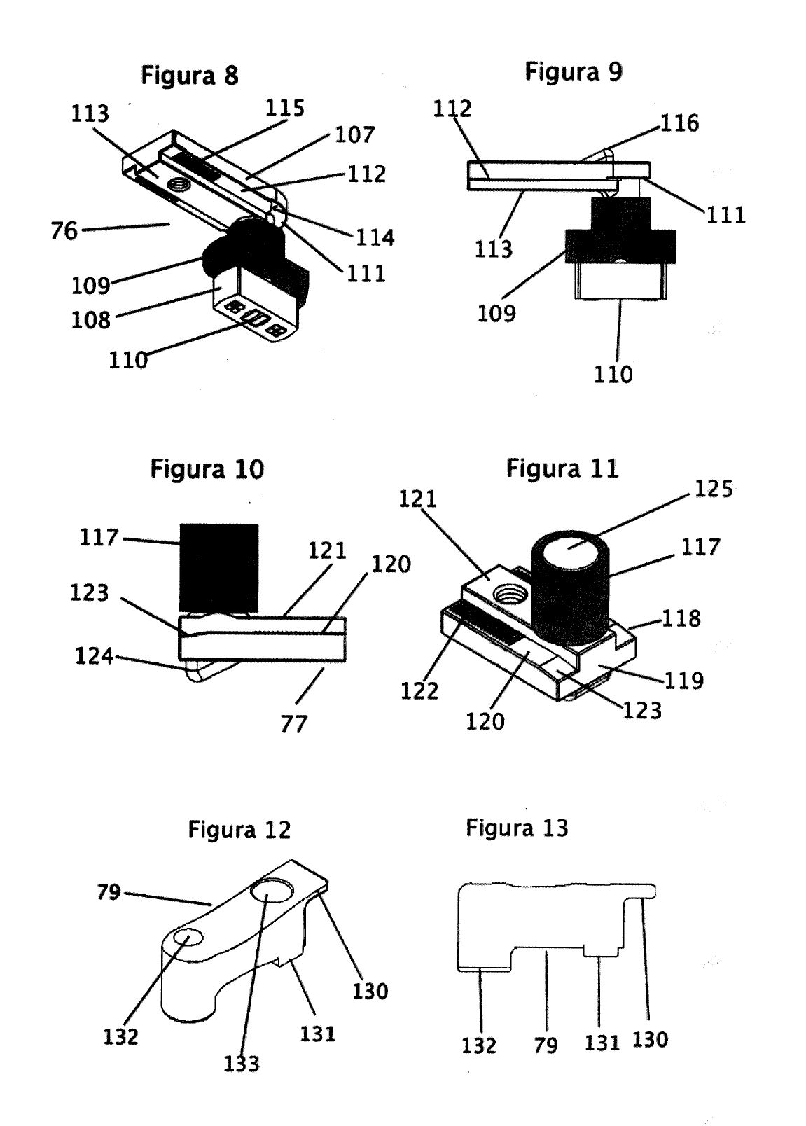

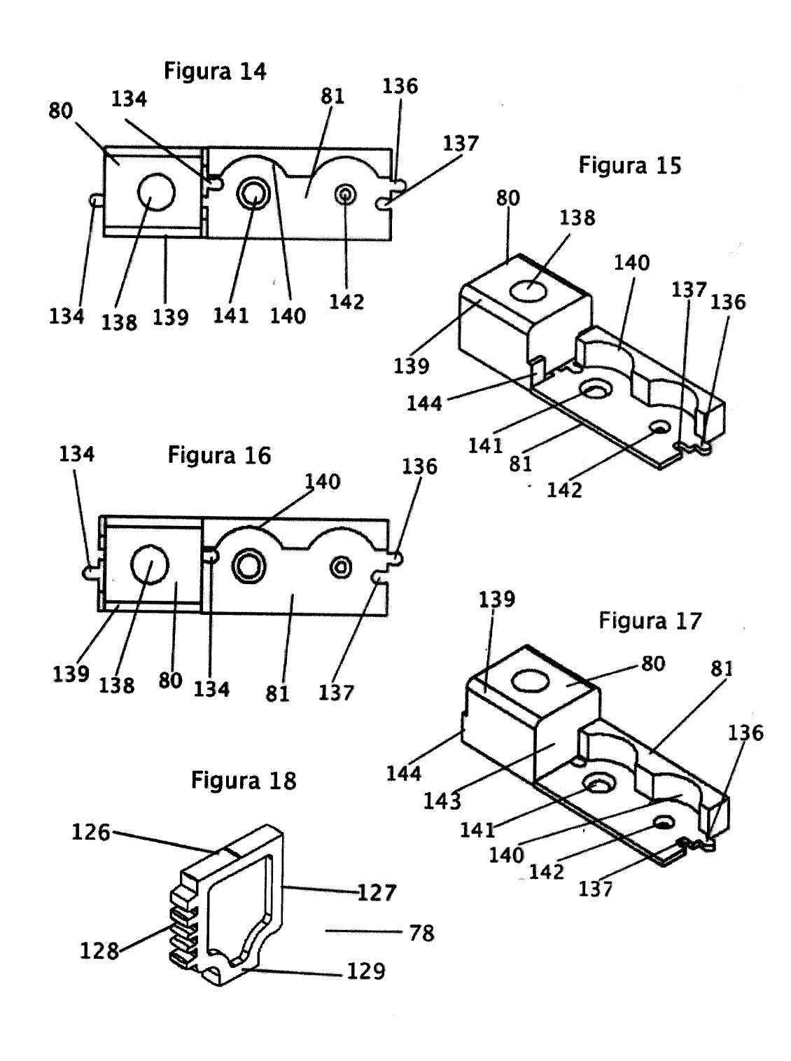

Third addition, wherein a new “U” shaped levelling profile (73), as shown in FIG. 3, is described. The levelling profile (73) base (97) accommodates the levelling sets (74), as shown in FIGS. 4 and 5. The levelling set is formed by an eccentric bolt (94) and a flat head screw (95). The screw (95) has a head (96) with a diameter big enough to assure a stable support of the aluminium track (7), the height of the screw (95) is design to level the track on uneven floor or ceiling surfaces. The eccentric bolt (94) has the precise dimensions to fit perfectly on the levelling profile (73) base and avoid any undesired movement and also provide a stable support basement for the whole system. On top of the levelling sets (74) is placed the bottom track (7). The side arms (92) of the levelling profile (73) centre the track (7) and hide the levelling sets (74) and fixation screws (50). The levelling profile base has two corner holes (93) to insert a cap, not shown in the figures, to avoid indoor water leakage at the track ends.

Fourth addition, wherein a new top turning set (75), depicted in FIGS. 4 and 5, has a metal body (97) and a top guide bushing (98). The metal body (97) is made in one piece by injection, assuring the part measurements and symmetries, for a perfect operation and eliminating the possible differences in different production batches.

The base of the metal body (97) is a plate with three layers (100, 101, 102) and a protuberance (103):
First layer (100) assures the right coupling in between the panes (1) when they are being deployed. This layer (100) has a reference mark (104) to insert this set (75) into the top profile (71) in the correct position, in such a way that all the panes will have the sets fitted at the same distance.
On the second layer there are small, teeth like, protuberances (105), up to 0.5 mm long, to fix tightly the set to the aluminium top profile.
The width of the third layer (102) assures a centred position of the set (75) in relation to the pane (1), as it has the same width as the top profile (71) opening (87).
The protuberance (103) has a wedge shape to support the set body and to assured a vertical position of the axis (106) over the top aluminium profile (71), and removing a second screw present in the former version of this set (75).
The top guide bushing (98) has a circular shape and two layers. It is one piece made of polyamide or similar material. This bushing (98) is inserted by pressure into the rounded axis metal head of the top turning set (75). The outer diameter in the bushing (98) assures the centred position of the pane (1) in relation to the top track (6) and avoids noises when the panes (1) are sliding,

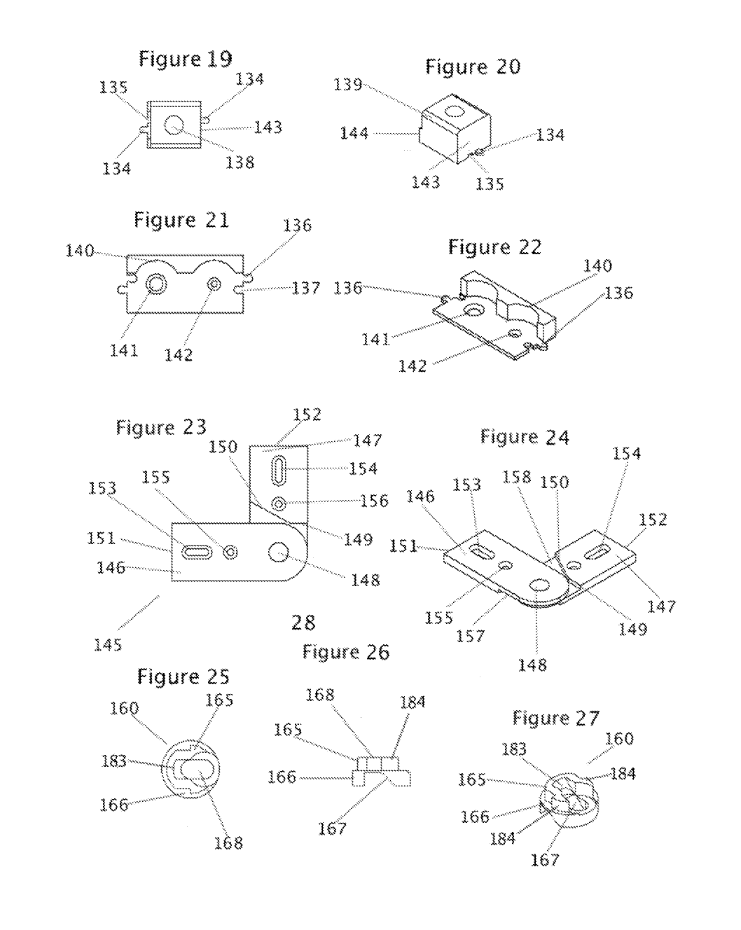

Fifth addition, wherein a new bottom turning set (76) replaces the one included in former patent request. As shown in FIGS. 6 and 7 the new bottom turning set (76) has a metal part with two bodies (107, 108) and a bottom guide bushing (109). The metal part is form by two injected metal bodies (107,108), assembled by a square click locking joint (110), that allows a part to enter into the other one but not to exit from the other one, it creates a rigid union that can't be disassembled, this way is assured that parts measurements and symmetries, for a perfect operation and eliminating the possible differences in different production batches.

The base of the metal body (107) is a plate with three layers (11,112,113) and a protuberance (116):
First layer (111) assures the right coupling in between the panes (1) when they are being deployed. First layer (111) has a reference mark (114) to insert this set in the correct position in such a way that all the panes will have the sets (76) fitted at the same distance in the aluminium bottom sliding profile (5), and assuring the right longitudinal position of the set (76) in relation to the bottom sliding profile (5).
Second layer (112) has on its surface small protuberances (115) to fix tightly the set (76) to the aluminium bottom sliding profile (5). This way, the protuberances (115) improves the fixation of the set (76).
The width of the third (111) layer assures a centred position of the set in relation to the bottom sliding profile (5), as it has the same width as the profile opening.
The protuberance (116) has a wedge shape to support the set body and to assured a vertical position of the axis (110) in relation to the bottom aluminium sliding profile (5), and removing a second screw present in the former version of this set.

The bottom guide bushing (109) has a “T” shape, side faces are flat and the front and rear ones are rounded. The bushing width (109) is smaller than the aluminium track (7) opening (56), therefore the panes (1) can be mounted and dismounted without the need of a hole in the track (7). The bottom guide bushing (109) is centred in relation to the set axis, but is not fixed, making possible to keep the parallelism between the flat sides of the bushing (109) and the aluminium track (7). The bottom guide set (76) solves a problematic situation present in the former version, as during the installation process it was necessary to insert a metal pin inside the plastic bushing, a delicate process that sometimes broke the plastic bushing. Also this breaking could happen if the operation of the panes was not correct or an object could fall inside the track and block the normal operation of the bushings. This breakage involved dismounting the whole system as the former bushing can't be introduced into the track from the top, it has to be done from one side of the track. So, there is no need to design a specific hole in the track as new version allows the top-down insertion into the track. Therefore, the bushing (109) width allows the panes (1) to be mounted and dismounted without the need of a hole in the track to insert these new sets inside.

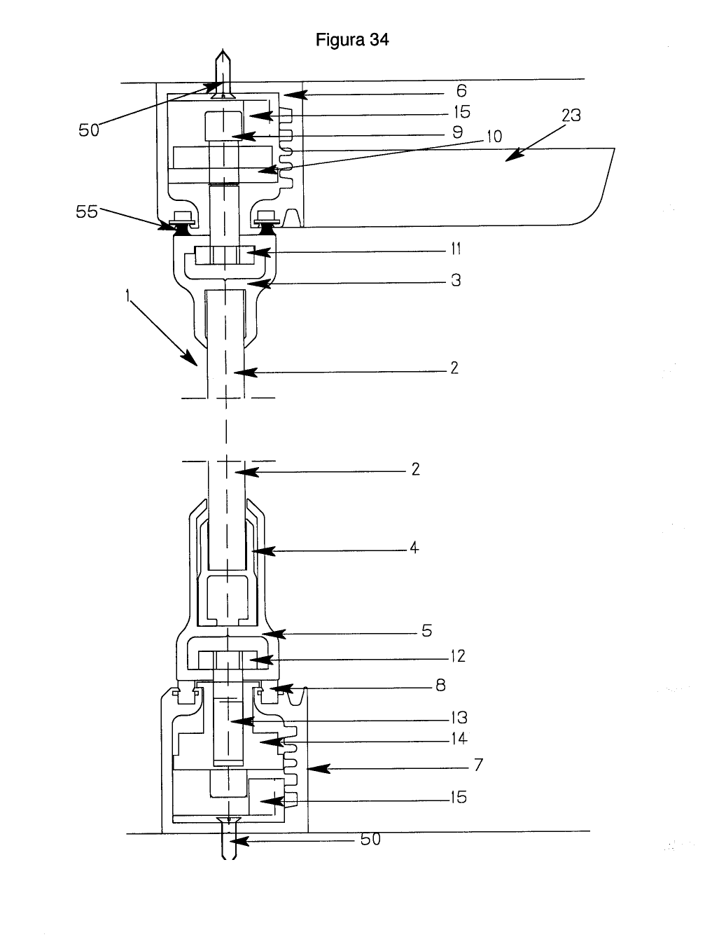

Sixth addition, wherein a new top guide (77) replaces former version made of a bushing (18) and a screw (30). As shown in FIGS. 10 and 11, the new top guide set (77) has a metal body (118) and a top guide bushing (117).

The metal body (118) is made in one piece by injection, this way is assured that parts measurements and symmetries, for a perfect operation and eliminating the possible differences in different production batches. The metal body is a plate (119) with two layers (120, 121), an axis (125) and a protuberance (124). On the first layer (120) there are small, teeth like, protuberances (122), to fix tightly the set to the aluminium top profile (72). This layer (120) has a downward slope (123) at its front end to ease the movement of the set (75) along the top profile (71) longitudinal hole. The width of the second layer (121) assures a centred position in relation to the pane (1), as it has the same width as the profile (71) opening. The protuberance (124) has a wedge shape to support the set body and to assured a vertical position of the axis (125) over the top aluminium profile (71), and removing a second screw present in the former version.

The top guide bushing (117) has a circular shape and two layers. It is one piece made of polyamide or similar material. This bushing (117) is inserted by pressure into the cylindrical axis (125) head of metal body (118). The outer diameter in the bushing (117) assures the centred position of the pane (1) in relation to the track (6) and avoids noises when the panes (1) are sliding.

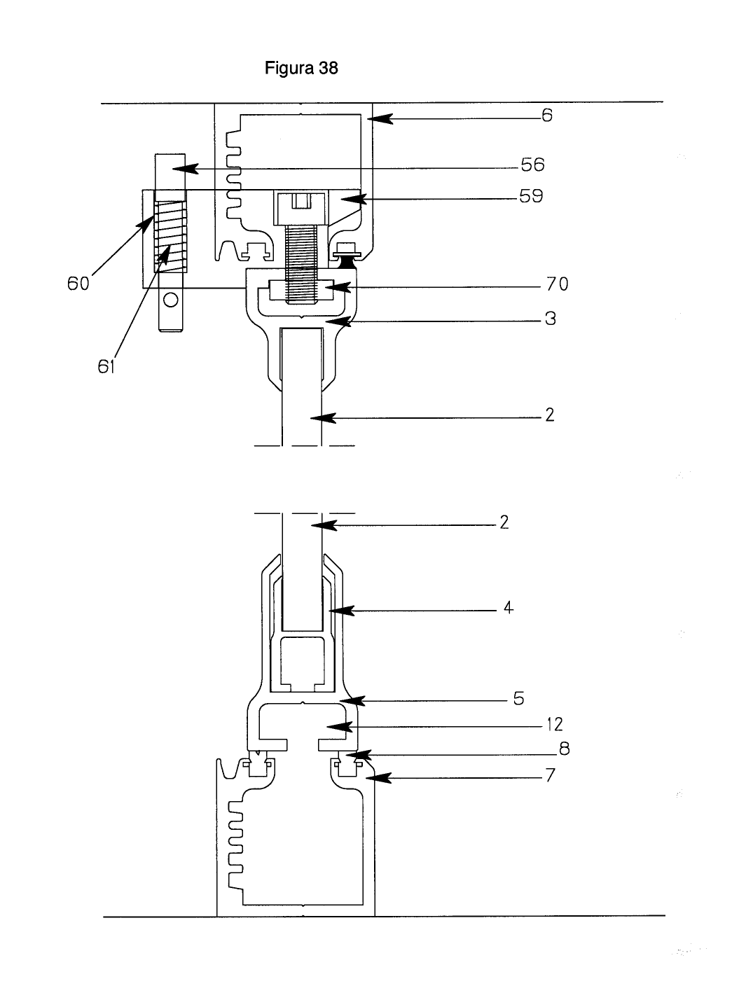

Seventh addition, wherein a cap (78) is placed at the ends of the bottom track (7). As shown in FIG. 18, the cap (78) shape is the same as the track (7) hole, so it can fit in perfectly. So the bottom side (126) is flat and the top side (129) narrows so it can fit into the hole (56) shown in FIG. 51. One vertical side (127) is flat while the other vertical side (128) has a contour with protuberances so it can fit perfectly into the protuberances (49) of the bottom track (7). The cap (78) is made in one piece by injection, this way the measurements are assured to be the right ones for a perfect coupling to the track (7) and achieving a hermetic termination in the track ends.

Else more, the bottom track (7) has small drills, not shown in the figures, in the outdoor side. So the any water coming into the track (7) from the panes (1) vertical joints can flow outdoor. So these caps (78) assure that water will flow through these small drills on the track (7) outdoor side instead of flowing through the track ends, normally in contact with the walls.

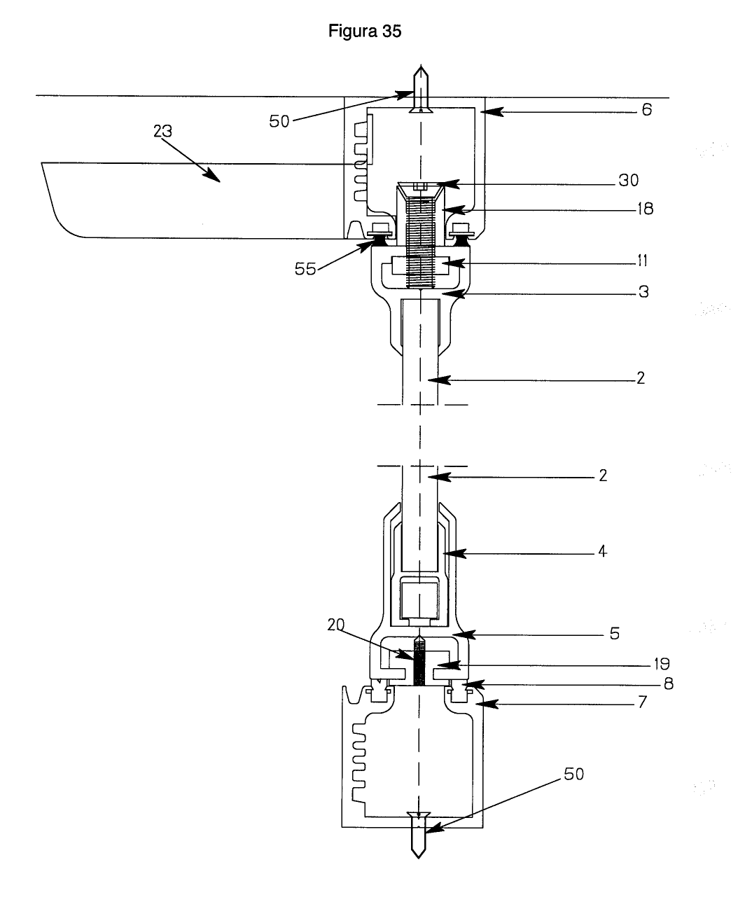

Eighth addition, wherein a new top locking block (79) replaces the former locking mechanism described in FIGS. 54 and 55. FIGS. 12 and 13 show the new top locking block (79) having on its base a protuberance (130) aim to position it perpendicularly to the top aluminium profile (71), avoiding any possible movement of this block. In the front side there is another protuberance (131) working as a stopper against the interior side of the top aluminium profile (71), positioning the door (24) in relation to the top aluminium track (71). This way, the door (24) is in line with the rest of the panes (1). These protuberances (130,131), position the block in relation to the top aluminium profile (71) and the top track (6), avoiding accidental marks on the outer faces of these profiles (6, 71) during the installation. The block (79) is made in one piece by injection, assuring a perfect coupling to the top aluminium profile (71), and avoiding differences in measurements in different production batches. The shape of block (79) is a rectangular parallelogram with two protuberances (130,131) and a semicircular side with a hole (132) with a higher height over the rest of the block (79) top side. A hole (133) with a bigger diameter than the former hole (132) is in the opposite side, having these holes (132, 133) the same use as the holes (60, 69) in the former door (24) locking mechanism.

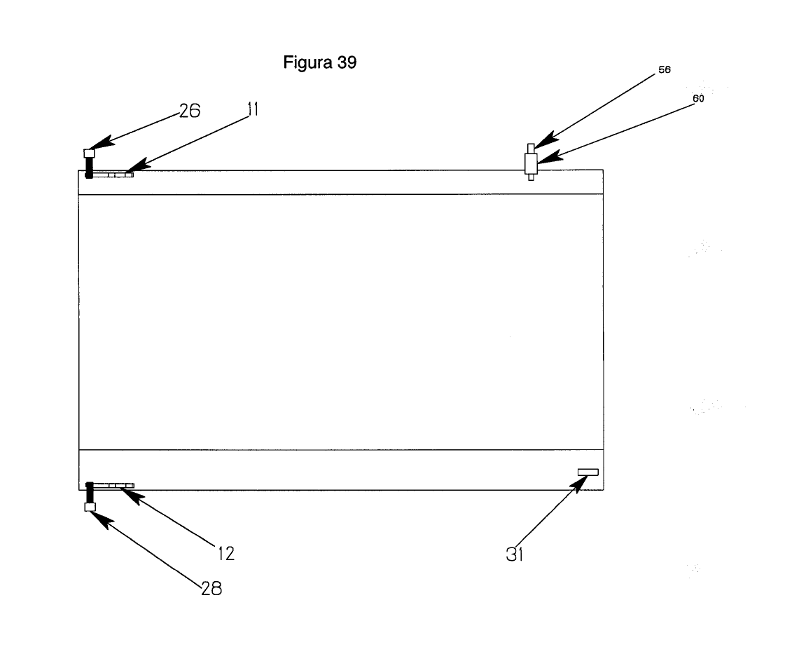

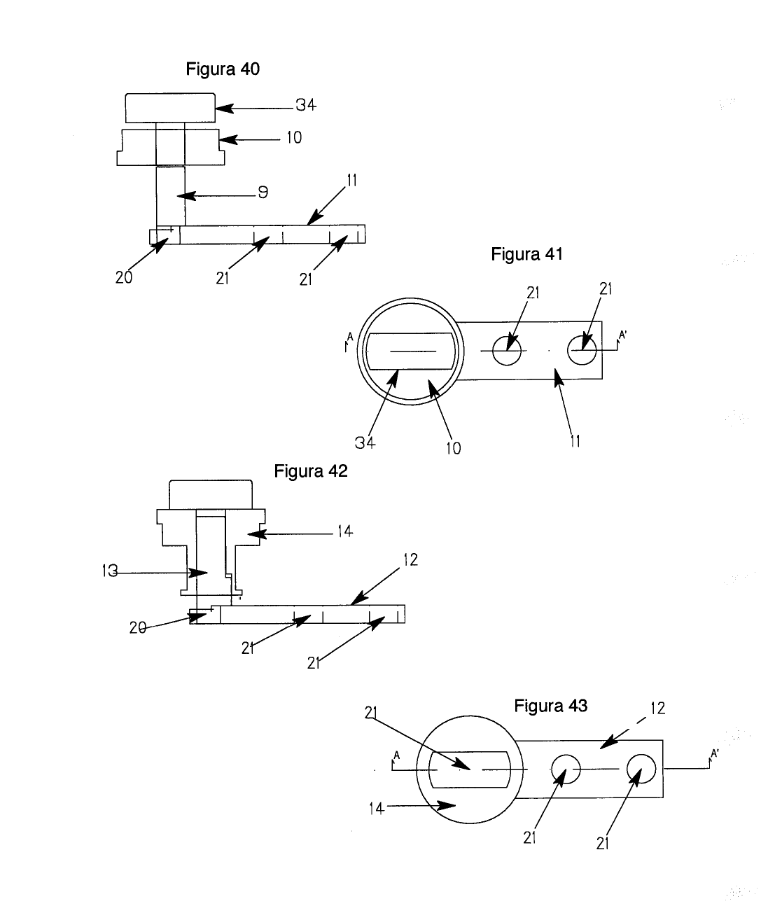

Ninth addition, wherein a new pivot block (80) and a turning mechanism set (81) replace former turning mechanism (15). As shown in FIGS. 22 to 29 this new set (80, 81) has two components:
Pivot block (80), shown in FIGS. 19 and 20, replaces the polyamide cubic shape pivot block (25) in the turning mechanism (11, 25, 26) described in the first patent request. Pivot block (80) has a rectangular shape in all its sides, and a hole (138), where the door (24) axes are inserted, that is slightly not centred as the top and bottom axes must have a shift between them for the correct operation of the panes (2). External sides of the pivot block (80), in contact with the vertical sides of the tracks (6,7), have a flat face and the other two sides (143,144) have a protuberance (134) and a hole (135) each, on their bottom. These protuberances (134, 136) have identical shapes and the holes (135, 137) also have the same geometry in such a way that protuberances (134, 136) fit into the holes (135, 137). Else more, one side (144) has a rectangular extension to match a perfect coupling with the turning mechanism (81).
The new turning mechanism (81), FIGS. 21 and 22, replaces the one in FIGS. 44 and 45. The turning mechanism (81) has the same protuberances (136) and holes (137) as the pivot block (80) but in a reverse position, so the pivot block (80) and the turning mechanism (81) can be assembled perfectly. When both parts (80, 81) are assembled they form a single block, so they can not be split. In the side not matched to the pivot block (80) can be assembled another turning mechanism (81) and so on, up to the number of spoons necessary, as many as panes (2). The turning mechanism (81) has two holes (141, 142). The hole (141) closer to the block pivot (80) has a bigger diameter than the other one (142), and is used to fix the tracks (6,7) to the floor and the ceiling, and the smaller one (142) is used to fix the turning mechanism (81) to the tracks (6, 7). The turning mechanism (81) has two spoons (140) as in the old version of the turning mechanism (15).

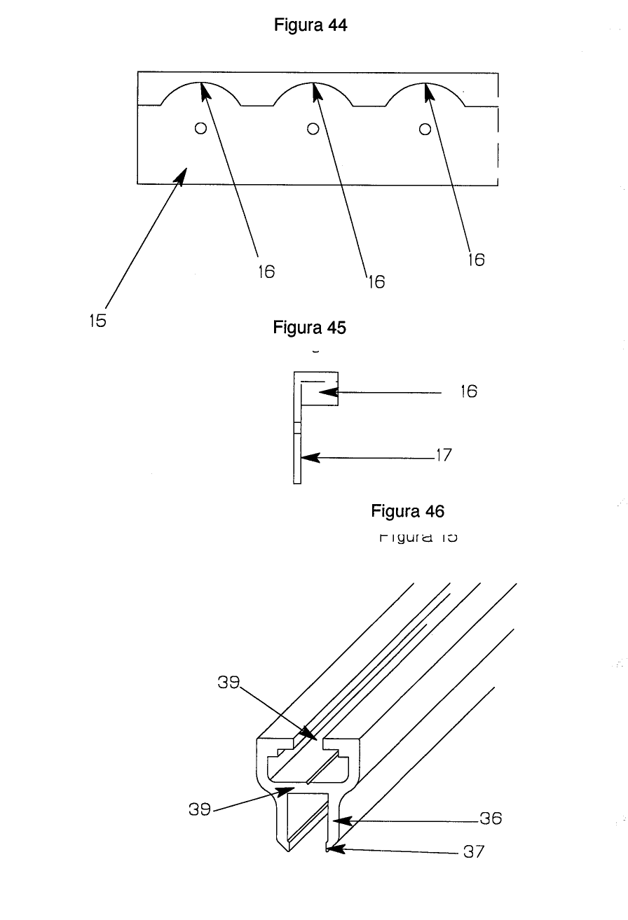

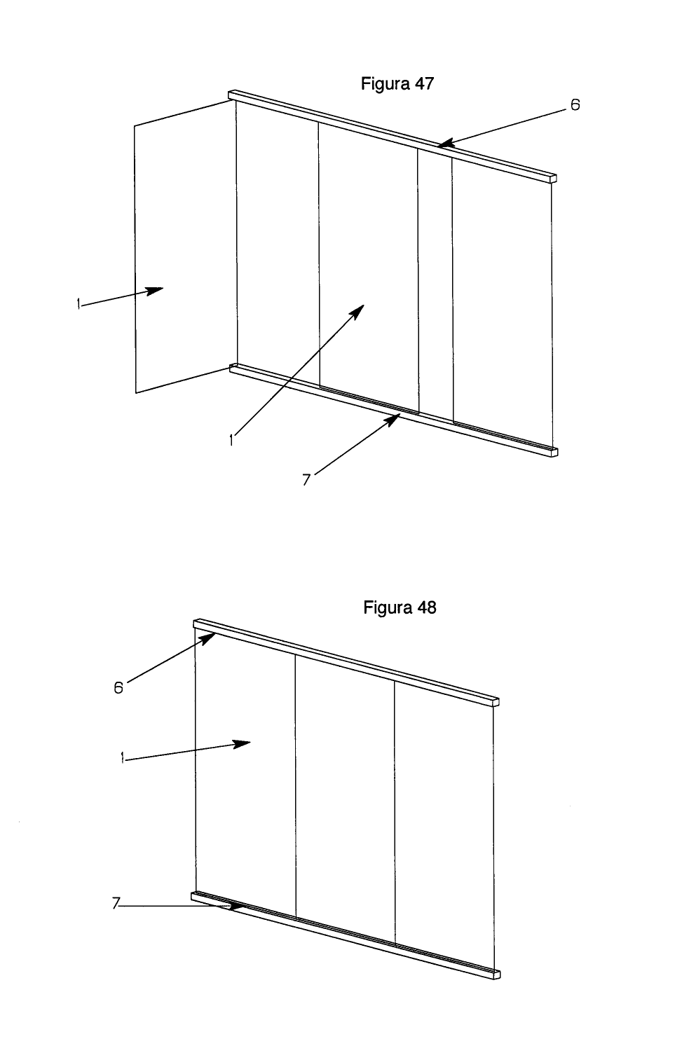

The new turning mechanism (81) and pivot block (80) set can be used on bottom, FIGS. 22 and 23, and top, FIGS. 24 and 25, of the windbreak system, and in any other possible opening configuration (right, left, interior, exterior) without any mechanical operation in the components. To achieve this, the pivot block (81) on the bottom must be assembled to the spoons plate, turning mechanism (81), using a different protuberance (134,136) and hole (135,137) than the one used in the top pivot block (80), as the axis hole position is not symmetric in the longitudinal axis defined by the longest sides of the block. This way, the installation process is easier and more reliable than the one described in the former patent request. Moreover, it is not necessary any mechanical operation for fitting them.

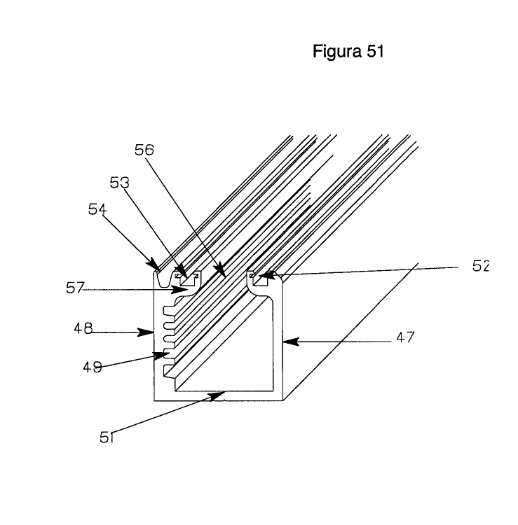

Tenth addition, wherein a two-part adjustable corner plate (145) can couple different sections, it can happen when there is an angle and two tracks must be connected. Moreover, the two-part adjustable corner plate assures that both sections won't move once they are assembled during the operation of the system. FIGS. 30 and 31 show that the two-part adjustable corner plate has two identical plates (146,147) connected by a joint (148) in the plates (146,147) rounded shape sides. These semicircular ends have a step so they can couple by means of the joint. This step is delimited by two straight edges (149, 150) forming an interior angle of 270°. The angle formed by these two edges (149,150) allow the set (145) to be used to articulate sections with two tracks (6, 7) within a range of 45° to 315°. The other small sides (151, 152) are straight. Along the central axis of the plates (146, 147) there is an oval hole (153, 154), whose longer axis is parallel to the longer sides of the plate, and a circular hole (154, 155), being the oval ones closer to the small straight side of the plates (146, 147).

The oval hole (153, 154) is always used before the other one when placing the plates (146, 147), as it allows a regulation on the track connection process. The second hole (155, 156) is used for the final fixing of the set (145), once the tracks are connected properly. The plates (146, 147) are made in one piece each by injection.

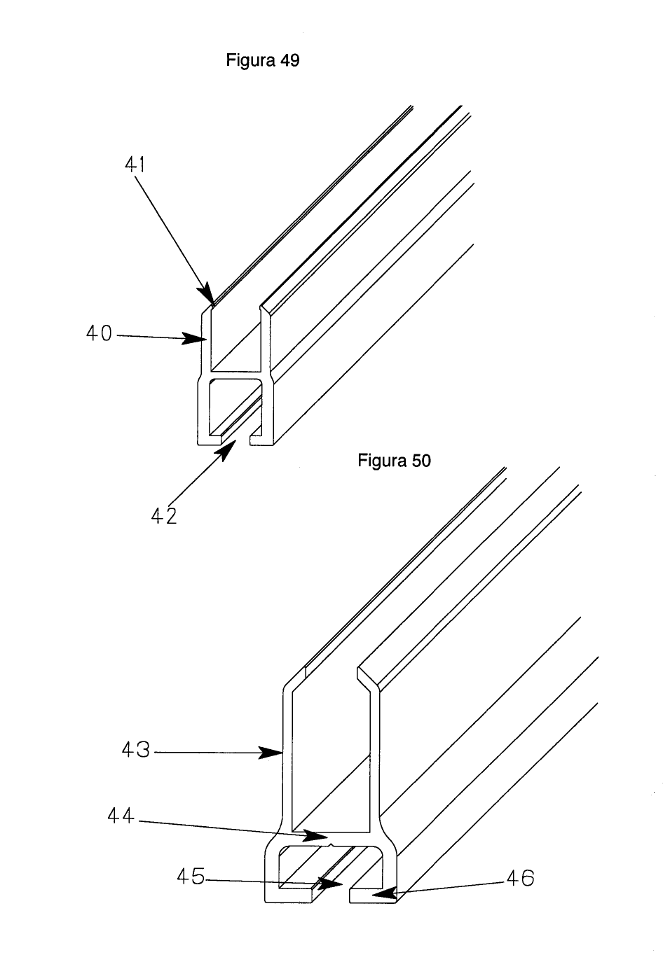

Eleventh addition, wherein a new top turning set eliminates the need of using the guide-arm (23) when folding the panes as described in the former patent request. The new set is formed by a metal axis (159) and a blocking bushing (160). The metal axis (159), FIGS. 28 and 29, has a cylindrical shape with three different areas (161, 162, 163). The bottom area (161) of the axis has a semicircular shape to be inserted in a fixing plate (70). Around the middle of the axis there are two wings (162) connected, with a ramp shape. This ramp will allow the blocking bushing (160) to slide up the axis until it reaches the pivot position at the top turning mechanism (81) height. At the top of the axis there is a head (163) with a small ramp that will press the blocking bushing (160) down the axis when the pane is going to be deployed, so it can leave the top turning mechanism. The front side of the head (164) has a rounded shape and will block the pane (1) when folded, as the axis rotates approximately 90° in relation to the blocking bushing (160), being blocked to the interior semicircular faces (165).

As depicted in FIGS. 25 to 27, the blocking bushing (160) has a circular shape, with a central hole (168) and two layers (165, 166). The top plan view shows that the hole (168) has an oval shape with straight arms in such a way that this hole (168) couples to the metal axis (159). The first layer (165), the one with the bigger diameter, has a ramp (167) that will elevate the bushing (160), as it slides up on it, until the blocking bushing (160) reaches to the top turning mechanism (81) height. The second layer (165) is symmetric to the central vertical axis and has an interior ramp (167) in the inner hole (168) and two rounded sides (165) to block the metal axis (159) when the pane (1) starts the rotation movement. When the pane (1) is going to be deployed the central ramp (167) of the blocking bushing (160) will slide down along the axis head ramp (162) and will press down the blocking bushing (160), therefore leaving the top turning mechanism (81).

The metal axis (159) and the blocking bushing (160) are made in one piece by injection assuring the part measurements and symmetries are the right ones, for a perfect operation and eliminating the possible differences in different production batches. As both parts (159, 160) form a set, it is not necessary to leave any tolerance, this way, the pane (1) is perfectly blocked since the beginning of the folding movement, so the guide-arm (23) to hold the pane (1) during this movement is not necessary anymore.

Twelfth addition, wherein a new bottom guide (169), having a metal plate (170) and a washer (171), made of polyamide or similar material, as shown in FIGS. 30 and 31, replaces the former one (12, 13, 14, 20, 21) as depicted in FIGS. 42 and 43. The base of the metal body (170) is a plate with two layers (173, 174). On the first layer (173) there are small, teeth like, protuberances (175), up to 0.5 mm long, to fix tightly the set (169) to the aluminium bottom profile (5). The opposite side of the first layer (173) base has a channel (172) with a width equal to the width of the opening (45) of the aluminium bottom profile (5), so the pane (1) and the set (169) are both in line. The height of the second layer (174) is the same as the thickness of the base of the bottom profile (5), so when this plate is fixed, this layer (174) will be at the same level as the base of the bottom profile (5) making the base at this point, a flat continuous surface. The plate (170) is made in one piece by injection to assure that all the measurements and symmetries are correct. This way, the set will work properly and will eliminate the minor differences among the plates in different production batches.

The washer (171), made of polyamide, has a round shape and a hole along its vertical axis, having two layers with different diameters. The bigger diameter layer (177) is designed to keep the pane (1) in line with the aluminium bottom track (7). The washer head (176) has a smaller diameter than the former and is used to couple with the metal body (170), by an arrow lock or click system, keeping these parts (170, 171) together. Nevertheless, the washer (171) can rotate freely as its cylindrical interior hole (178) matches a cylindrical pin, not numbered in the figure, based on the first layer (173) of the metal body (170) and with a height equal to the second layer (174).

This new bottom guide set (169) eliminates the need of making a notch in one of the two sliding strips inserted in the bottom track, making this support area completely flat and continuous. This way the base of the bottom profile (5) won't hit or get stuck in the sliding strips during the pivoting movement, making the operation of the system smoother. Another improvement is that the possibility of damaging the strips, while folding the panes, is removed.

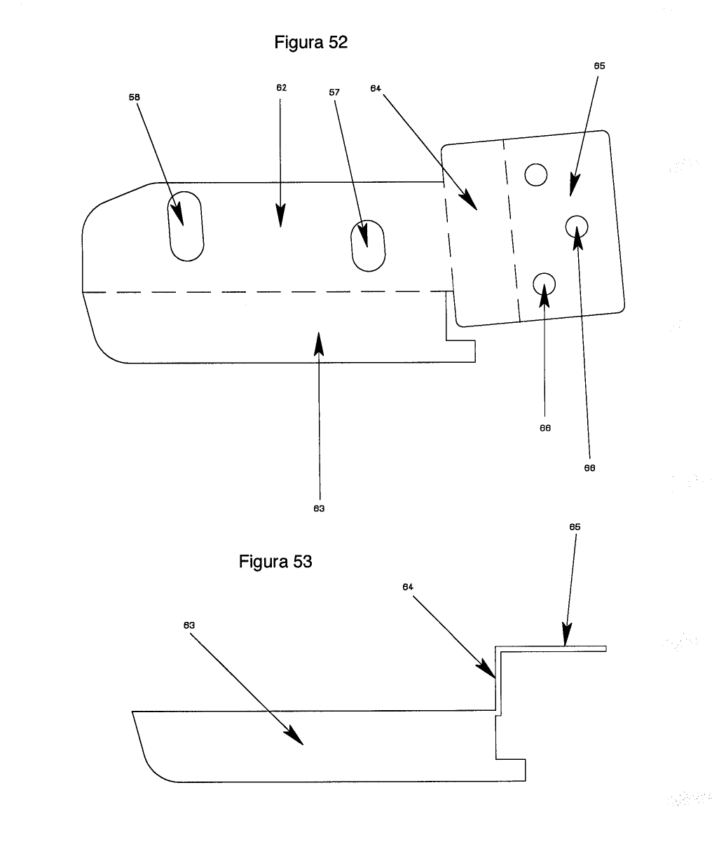

Thirteenth addition, wherein a wedge (179) has three layers with a rounded side. As depicted in FIGS. 32 and 33, first layer (180) is a base placed underneath the two-part adjustable corner plate (145). It has that rounded side to allow the plates (146, 147) to move while connecting two tracks, and at the same time keep the wedge (179) at a fix position when the panes (1) pass along the corner. The second layer (181) connects the first (180) and third one (182) and fills the gap in between the corner and the rounded plates (146, 147) when connecting two sections with angles. The third layer (182) has a rounded shape to avoid the bottom turning (76) bushing (109) to get stuck in the corner and pass along the tracks (7) smoothly from one section to another.

The rounded side wedge (179) is made in one piece by injection to ensure having the right measurements for a perfect coupling with the two-part adjustable corner plate (145) and the bottom track (7) and eliminating possible differences in measurements in different production batches.

### INDUSTRIAL APPLICATION

This invention has an industrial application in the technical sector of construction mobile structures.

1-9. (canceled)

10. Windbreak system formed by a set of foldable and independent panes sliding in a longitudinal way along a top track and a bottom track that supports the weight of every pane, and a foldable and not sliding door with a pivot axis, having all the panes and door a pivot and folding axis wherein each pane and door has a glass glued to:
the internal face of the side arms and the flat base in the top profile. These sides have an arm shape having on their inner faces small protuberances, teeth like, up to 0.5 millimetres long, and having both arms have a cavity on the top area and the terminations of these arms have two flat sides, and the bottom area of the profile has an inverted “U” shape hole to insert and fix the new top turning et and top guide set,
the side arms internal faces and a flat base of the new bottom aluminium profile, wherein the side arms have, on their interior face, small protuberances, teeth like, up to 0.5 mm long and the bottom area of the profile has an inverted “U” shape hole to insert two bolts that fix this profile to the bottom sliding profile base,
and the bottom track is identical to the top track being the section rectangular, with a half open side whose opening is delimited by two equidistant sides in the track and because one inside wall of the track is flat and the other vertical wall has a set of protuberances that conform a virtual wall, equidistant from the former, and the track side in contact with the ceiling or floor has a notch channel all along the inner face opposite to the track opening, and the exterior face of the side that conforms the opening has two equidistant channels where two strips, one each channel, made of a homogeneous mixture of self-lubricating polymer are fitted, in the bottom track, and brushes are placed in the top track, and a third channel working as a water collection channel, and the bottom track has some drills, parallel to the bottom track sides,
being the top profile connected, at the folding axis, to the top track by a top guide set formed by a metal body and a top guide bushing wherein the metal body is a plate with two layers, an axis and a protuberance, on the first layer there are small, teeth like, protuberances, this layer has a downward slope at its front end, and the width of the second layer has the same width as the profile opening, and the top guide bushing has a circular shape and is one piece made of polyamide or similar material being inserted by pressure into the cylindrical axis head of metal body and the outer diameter in the bushing has a width similar to the opening in the top track,
being the bottom sliding profile connected, at the folding axis, to the bottom track by a bottom guide set formed by a metal plate and a washer, made of polyamide or similar material, and the base of the metal body is a plate with two layers, on the first layer there are small, teeth like, protuberances, up to 0.5 mm long, at the opposite side of the first layer base has a channel with a width equal to the width of the opening of the aluminium bottom profile and the height of the second layer is the same as the thickness of the base of the bottom profile and the washer, made of polyamide, has a round shape and a hole along its vertical axis, having two layers with different diameters, the bigger diameter layer and the washer head has a smaller diameter than the former, and the polyamide washer is inserted in the metal body by pressure through its cylindrical interior hole into a pin based on the first layer of the metal body and with a height equal to the second layer.

11. Windbreak system according to claim 10, wherein bottom track accommodates in a “U” shaped levelling profile, resting on some levelling sets formed by an eccentric bolt, with the precise dimensions to fit perfectly in the levelling profile base, and a flat head screw, resting all these sets completely on the base of the profile, wherein there are two corner holes to insert a cap.

12. Windbreak system formed by a set of panes and door according to claim 11, wherein the pivot axis of each pane is formed by:
a top turning set having a metal body and a top guide bushing, the metal body base is a plate with three layers and a protuberance wedge shaped, the first layer has a reference mark, in the second layer there are small, teeth like, protuberances, up to 0.5 mm long, and the width of the third layer, showing the top guide bushing a circular shape and two layers being the biggest dimension of the bushing, and the bushing is inserted by pressure into the rounded axis metal head of the top turning set,
a bottom turning set having bottom guide bushing, a metal plate and another metal part with an oval shape and straight sides, being these metal bodies assembled by a square click locking joint, and the base of the metal body is a plate with three layers and a protuberance, in the first layer there is a reference mark, the second layer has on its surface small protuberances and the width of the third layer has the same width as the profile opening, the protuberance has a wedge shape and the bottom guide bushing has a “T” shape, side faces are flat and the front and rear ones are rounded and the bushing width is smaller than the aluminium track opening, being centred, but not fixed, in relation to the set axis,
a pivot block and turning mechanism, wherein, the pivot block has a rectangular shape in all its sides, and a hole, where the door axes are inserted, that is slightly not centred, and the external sides of the pivot block and the other two sides have a protuberance and a hole for the assembling with the turning mechanism, having one side a rectangular extension to match the turning mechanism and the turning mechanism, has the same protuberances and holes as the pivot block but in a reverse position, including two holes, and the hole closer to the block pivot has a bigger diameter than the other one, and has two spoons.

13. Windbreak systems according to claim 12, wherein the panes and the door pivot with the help of a mechanism formed by a metal axis and a blocking bushing characterized by
The metal axis has a cylindrical shape with three different areas, the bottom area has a semicircular shape, around the middle of the axis there are two wings connected, with a ramp shape and at the top of the axis there is a head with a small ramp in its base and the front side of the head has a rounded shape and will block the pane when folded, as the axis rotates approximately 90° in relation to the blocking bushing, being blocked to the interior semicircular faces,
the blocking bushing has a circular shape, with a central hole and two layers, showing the hole an oval shape with straight arms grasping the metal axis, and the first layer has a ramp that rests on the ramp of the metal axis, and the second layer is symmetric to the central vertical axis and has an interior ramp in the inner hole and two rounded sides that block the metal axis.

14. Windbreak system according to claim 13, wherein the door locking system includes a top locking block made in one piece by injection, the block is a rectangular parallelepiped with two protuberances and a short semicircular side with a hole, of a bigger diameter than the hole, placed on the top side, opposite to the protuberance of the block, having a protuberance aim to position it perpendicularly to the top aluminium profile, and another protuberance in the front side that works as a stopper against the interior side of the top aluminium profile.

15. Windbreak system according to claim 11, wherein a cap is placed at the ends of the bottom track, the cap shape is the same as the track hole, the bottom side is flat and the top side narrows so it can fit into the hole, being one vertical side flat and the opposite vertical side has a contour with protuberances complementary to the protuberances of the bottom track.

16. Windbreak system according to claim 12, wherein the sections that are not in line include a two-part adjustable corner plate having two identical plates connected by a joint in the plates rounded shape sides having a step delimited by two straight edges forming an interior angle of 270° and the other small sides are straight, and along the central axis of the plates there is an oval hole, whose longer axis is parallel to the longer sides of the plate, and a circular hole, being the oval ones closer to the small straight side of the plates.

17. Windbreak system according to claim 16, wherein a wedge has three layers, the first layer is a base placed underneath the two-part adjustable corner plate, the second layer is shorter and narrower than the other two layers and the third layer has a rounded shape.

18. Windbreak system according to claim 16, wherein the top turning guide metal body, the two metal bodies in the bottom turning set, the caps, the locking block, the turning mechanism and its pivot block, the two-part adjustable corner plate, metal axis and the blocking bushing, the plate in the new bottom guide and the wedges are made in one piece by injection using aluminium, stainless steel or other metal alloys.
